(19) United States
(12) Patent Application Publication
(10) Pub. No.: US 2025/0276937 A1
(43) Pub. Date: Sep. 4, 2025

(54) DISPERSION OF (METH)ACRYLATE COPOLYMER AND USE THEREOF AS A BINDER FOR CEMENTITIOUS MATERIALS

(71) Applicant: BASF SE, Ludwigshafen am Rhein (DE)

(72) Inventors: Sheng Xian WANG, Shanghai (CN); Zheng Nan YANG, Shanghai (CN); Zhong ZENG, Shanghai (CN)

(21) Appl. No.: 18/862,593

(22) PCT Filed: Apr. 28, 2023
(86) PCT No.: PCT/EP2023/061296

§ 371 Date: Nov. 4, 2024

(30) Foreign Application Priority Data
May 5, 2022 (WO) PCT/CN2022/090901

(51) Int. Cl. C04B 24/26; C08F 220/18

(52) U.S. Cl. CPC C04B 24/2688; C08F 220/1802; C08F 220/1804; C08F 2800/20

(57) ABSTRACT

The present invention relates to a dispersion of (meth)acry late copolymer polymerized with hydroxyalkyl (meth)acrylate comonomer unit and use thereof for cementitious materials. The polymer dispersion according to the present invention could have good tensile strength and adhesion strength. More importantly, it has ammonia and aldehyde release.

### FIELD OF THE INVENTION

The present invention relates to a dispersion of (meth)acrylate copolymer polymerized with hydroxyalkyl (meth)acrylate comonomer unit and use thereof for cementitious materials.

### BACKGROUND OF THE INVENTION

Flexible polymer modified cementitious materials are widely used in apartments, basements, underground water tanks, etc. due to their good tensile strength, adhesion, flexibility, impermeability, corrosion resistance, cracking resistance, durability and the like. Polymer dispersions are often used in flexible polymer modified cementitious waterproofing materials as a modifier. In practice, polymer dispersions of acrylate copolymer and ethylene-vinyl acetate copolymer are conventionally used, wherein dispersions of acrylate copolymer containing (meth)acrylamide comonomer are most widely used due to the good workability and properties of the modified cementitious waterproofing materials.

CN102911580 A discloses a cross-linked acrylic dispersion for waterproofing coatings which has strong cross-linking density, excellent adhesion to cementitious substrates, strong adhesion, coating strength and excellent cement retarding ability.

The dispersion can be applied to both one- and two-component waterproofing coatings. The dispersion is prepared from deionized water, an initiator, an emulsifier, n-butyl acrylate, styrene, N-hydroxymethyl acrylamide, diacetone acrylamide, adipic dihydrazide, a defoamer and a neutralizer.

CN101891859 A discloses an elastic styrene-acrylic dispersion for a polymer cement waterproofing coating, which provides improved toughness, strength and waterproofing property of the resulted coating film. The dispersion is prepared from fatty alcohol polyoxy ethylene ether sulfate, fatty alcohol polyoxyethylene ether (meth)acrylate, n-butyl acrylate, styrene, AMPS and N-hydroxymethyl acrylamide.

WO2016001256A1 discloses a dispersion of (meth)acrylate copolymer containing a hydroxyalkyl (meth)acrylate comonomer unit, which is obtained from polymerization of monomers comprising, based on the total monomer weight, (a) from 25 to 45% by weight of at least one monovinyl aromatic monomer and/or methyl methacrylate; (b) from 50 to 70% by weight of at least one C₄₋₈ alkyl (meth)acrylate; (c) from 2 to 7% by weight of at least one hydroxyalkyl (meth)acrylate; (d) from 0 to 1% by weight of at least one α, β-monoethylenically unsaturated C₃₋₆ monocarboxylic or dicarboxylic acid; and (e) from 0 to 0.65% by weight of (meth)acrylamide, N-hydroxyalkyl (meth)acrylamide, and/or 2-acrylamido-2-methylpropane sulfonic acid, and use thereof for flexible cementitious waterproofing materials.

There are many drawbacks of such kind of dispersions. One is the ammonia release to the environment due to the hydrolysis of acrylamino group upon mixing with cement under strong alkali condition which is resulted from cement hydration. Ammonia is an irritant and can cause burns of skin, eyes, mouth and lungs. Another drawback is the release of aldehyde to the environment. And aldehyde could post even more threat to human health. A third drawback is that the mechanical property, such as tensile strength, elongation and adhesion strength, are not optimized. Last, but not least, many approaches have been taken to improve the performance of the dispersion polymer, they often result in the improvement of the performance in some aspects at the expense of deteriorating the performance in some other aspects.

It would be advantageous to provide a polymer dispersion useful for cementitious materials with low the ammonia and aldehyde release and good the mechanical property.

### SUMMARY OF THE INVENTION

One aspect of the present invention relates to a dispersion of (meth)acrylate copolymer obtained from polymerization of monomers comprising, based on the total monomer weight,
(a) from 10 to 45% by weight of at least one monoethylenical hard monomer;
(b) from 54 to 89% by weight of at least one monoethylenical soft monomer;
(c) from 0.5 to 5.0% by weight of at least one monomer represented by Formula (1)

CH₂═C(R¹)CONR²R³ Formula (1)
wherein R¹ represents a hydrogen atom or a methyl group, R² is a hydroxyalkyl group containing 2 to 8 carbon atoms, R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

Another aspect of the present invention is to provide the use of the abovementioned dispersion polymer as cementitious materials.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The designation (meth)acrylate and similar designations are used herein as an abbreviated notation for “acrylate and/or methacrylate”.

The designation (meth)acrylate copolymer and similar designations are used herein refer to copolymers prepared by reaction of monoethylenical monomers including but not limited to (meth)acrylate monomers, monovinyl aromatic monomer, etc. as well as other reactive monomers.

All percentages and ratios denote weight percentages and weight ratios unless otherwise specified.

Within the context of the present application, the term Fox Tg refers to a glass transition temperature Tg as calculated according to the following Fox equation as disclosed in T. G. Fox, Bulletin of the American Physical Society, Volume 1, Issue No.

3, page 123 (1956):

$$1 / Tg = {W}_{1} / {Tg}_{1} + {W}_{2} / {Tg}_{2} + … + {W}_{n} / {Tg}_{n}$$

wherein
W₁, W₂, . . . . Wₙ are the mass fractions of the monomers 1, 2, . . . n, respectively, and
Tg₁, Tg₂, . . . . Tgₙ are the glass transition temperatures of homopolymers of the monomers 1, 2, . . . n in degrees Kelvin, respectively.

The Tg values for homopolymers of the majority of monomers are known and are listed in, for example, Ullmann's Ecyclopedia of Industrial Chemistry, Vol. 5, Vol. A21, page 169, VCH Weinheim, 1992. Other sources of glass transition temperatures of homopolymers include, for example, J. Brandrup, E. H. Immergut, Polymer Handbook, 1st Edition, J. Wiley, New York 1966, 2nd Edition, J. Wiley, New York 1975, and 3rd Edition, J. Wiley, New York 1989.

In the present invention, a monoethylenical monomer is regarded as a hard monomer if it can result a homopolymer with a calculated Fox Tg of over 10° C., otherwise, it will be regarded as a soft monomer.

The dispersion of (meth)acrylate copolymer obtained from polymerization of monomers comprising, based on the total monomer weight,
(a) from 10 to 45% by weight of at least one monoethylenical hard monomer;
(b) from 54 to 89% by weight of at least one monoethylenical soft monomer;
(c) from 0.5 to 5.0% by weight of at least one monomer represented by Formula (1)

CH₂═C(R¹)CONR²R³ Formula (1)
wherein R¹ represents a hydrogen atom or a methyl group, R² is a hydroxyalkyl group containing 2 to 8 carbon atoms, and R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

The at least one monoethylenical hard monomer (a) may include, but not limited to, methyl methacrylate, t-butyl acrylate, benzyl methacrylate, ethyl methacrylate, maleic acid vinyl alcohol, vinyl acetate, vinyl butyrate, vinyl formate, vinyl valerate, vinyl versitat, monovinyl aromatic monomer and any combinations thereof. The monovinyl aromatic monomer is selected from the group consisting of styrene, α-methyl styrene, o- or p-vinyl toluene, p-bromo styrene, p-tert-butyl styrene, o-, m- or p-chloro styrene, and any combinations thereof.

In a preferred embodiment, the at least one monoethylenical hard monomer (a) is selected from methyl methacrylate and styrene. In a more preferred embodiment, the at least one monoethylenical hard monomer (a) is styrene.

The monomer (a) is preferably used in an amount of 15% to 45%, more preferably 20% to 40%, most preferably 20% to 30% based on the total weight of all monomers.

The at least one monovinyl aromatic monomer and the methyl methacrylate monomer, if both are used, may be in any ratio.

The at least one monoethylenical soft monomer (b) may include, but not limited to, methyl acrylate, n-butyl acrylate, 2-ethylhexyl acrylate, isooctyl acrylate, nonyl acrylate, ethyl acrylate, decyl methacrylate, isodecyl methacrylate, hexyl (meth)acrylate, cyclohexyl acrylate, dodecyl (meth)acrylate, octyl methacrylate, propyl acrylate, ethylene adipate, diethyl fumarate, 1,4-butadiene, 1-pentenylene, di-2-ethylhexyl maleate, di-2-ethylhexyl fumarate and mixtures thereof.

In a preferred embodiment, alkyl acylates with 4 to 12 carbon atoms in the alkyl group, such as n-butyl acrylate and 2-ethylhexyl acrylate, are used as the soft monomers.

The at least one monoethylenical soft monomer (b) is preferably used in an amount of 54% to 84%, more preferably 59 to 79%, most preferably 69 to 79%, based on the total weight of all monomers.

The monomer (c) represented by Formula (1) may have R² is a hydroxyalkyl group containing 2 to 8 carbon atoms and R³ is H, alkyl or hydroxyalkyl group containing 2 to 8 carbon atoms. Preferably, R² is a hydroxyalkyl group containing 2 to 6 carbon atoms and R³ is H, C₁-C₆ alkyl or hydroxyalkyl group containing 2 to 6 carbon atoms. More preferably, R² is a hydroxyalkyl group containing 2 to 4 carbon atoms and R³ is H, C₁-C₄ alkyl or hydroxyalkyl group containing 2 to 4 carbon atoms.

More specifically, the hydroxyalkyl group may be selected from, but not limited to, hydroxyethyl, hydroxypropyl, hydroxybutyl, hydroxypentyl, hydroxyhexyl, hydroxylheptyl and hydroxyloctyl. More specifically, the monomer (c) may choose from, but not limited to, N-(2-hydroxyethyl) acrylamide, N-(2-hydroxyethyl) methacrylamide, N-(2-hydroxypropyl) acrylamide, N-(2-hydroxypropyl) methacrylamide, N-(1-hydroxypropyl) acrylamide, N-(1-hydroxypropyl) methacrylamide, N-(3-hydroxypropyl) acrylamide, N-(3-hydroxypropyl) methacrylamide, N-(2-hydroxybutyl) acrylamide, N-(2-hydroxybutyl) methacrylamide, N-(3-hydroxybutyl) acrylamide, N-(3-hydroxybutyl) methacrylamide, N-(4-hydroxybutyl) acrylamide, N-(4-hydroxybutyl) methacrylamide N, N-Bis(2-hydroxyethyl) acrylamide, N, N-Bis(2-hydroxyethyl) methacrylamide, N,N-Bis(1-hydroxypropyl) acrylamide, N,N-Bis(1-hydroxypropyl) methacrylamide, N,N-Bis(2-hydroxypropyl) acrylamide, N,N-Bis(2-hydroxypropyl) methacrylamide, N,N-Bis(3-hydroxypropyl) acrylamide, N,N-Bis(3-hydroxypropyl) methacrylamide, N,N-Bis(2-hydroxybutyl) acrylamide, N,N-Bis(2-hydroxybutyl) methacrylamide, N,N-Bis(3-hydroxybutyl) acrylamide, N,N-Bis(3-hydroxybutyl) methacrylamide, N, N-Bis(4-hydroxybutyl) acrylamide, N, N-Bis(4-hydroxybutyl) methacrylamide and any combination thereof. In a preferred embodiment, monomer (c) is chosen from N-(2-hydroxyethyl) acrylamide and N,N-Bis(2-hydroxyethyl) methacrylamide.

Monomer (c) may be used in an amount of 0.5% to 4%, preferably in an amount of 0.8% to 3%, more preferably in the amount of 0.8 to 2.2%, most preferably in the amount of 1 to 2%, based on the total weight of all monomers.

The monomer (d), i.e., the hydrophilic monoethylenically unsaturated monomer may include, but is not limited to, monoethylenically unsaturated carboxylic acids, such as (meth)acrylic acid, itaconic acid, fumaric acid, citraconic acid, sorbic acid, cinnamic acid, glutaconic acid and maleic acid; monoethylenically unsaturated carboxylic anhydride, such as itaconic acid anhydride, fumaric acid anhydride, citraconic acid anhydride, sorbic acid anhydride, cinnamic acid anhydride, glutaconic acid anhydride and maleic acid anhydride; and hydroxyalkyl esters of monoethylenically unsaturated carboxylic acids, such as hydroxyethyl (meth)acrylate and hydroxypropyl (meth)acrylate.

The monomer (d), if present, is preferably used in an amount of 0.5% to 25%, preferably in an amount of 1% to 15%, more preferably 1.5% to 10%, based on the total weight of all monomers.

Many other monoethylenically unsaturated monomer may be used in the present invention. Such monomers may include, but not limited to, vinyl alkanoate monomers and monoethylenically unsaturated di- and tricarboxylic ester monomers. The vinyl alkanoate monomers may include vinyl esters of C₂-C₁₁-alkanoic acids, for example, but not limited to, vinyl acetate, vinyl propionate, vinyl butanoate, vinyl valerate, vinyl hexanoate, vinyl versatate or a mixture thereof. The monoethylenically unsaturated di- and tricarboxylic ester monomers may include, but not limited to, diethyl maleate, dimethyl fumarate, ethyl methyl itaconate, dihexyl succinate, didecyl succinate or any mixtures thereof.

The monomers for the present invention may further comprise one or more crosslinking monomers. The crosslinking monomers can be chosen from di- or poly-isocyanates, polyaziridines, polycarbodiimide, polyoxazolines, glyoxals, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol (meth)acrylamide, (isobutoxymethyl) acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl) trimethoxysilane and (3-methacryloxypropyl) trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof.

It is to be understood that the total percentage of all monomers is 100% by weight.

In a preferred embodiment, the dispersion of (meth)acrylate copolymer obtained from polymerization of monomers comprising, based on the total monomer weight,
(a) from 15 to 45% by weight of at least one monoethylenical hard monomer;
(b) from 54 to 84% by weight of at least one monoethylenical soft monomer;
(c) from 0.5 to 4% by weight by weight of at least one monomer represented by Formula (1)

CH₂═C(R¹)CONR²R³ Formula (1)
wherein R¹ represents a hydrogen atom or a methyl group, R² is a hydroxyalkyl group containing 2 to 8 carbon atoms and R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

In a more preferred embodiment, the dispersion of (meth)acrylate copolymer obtained from polymerization of monomers comprising, based on the total monomer weight,
(a) from 20 to 40% by weight of at least one monoethylenical hard monomer;
(b) from 59 to 79% by weight of at least one monoethylenical soft monomer;
(c) from 0.8 to 2.2% by weight by weight of at least one monomer represented by Formula (1)

CH₂═C(R¹)CONR²R³Formula(1)
wherein R¹ represents a hydrogen atom or a methyl group, R² is a hydroxyalkyl group containing 2 to 8 carbon atoms and R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

In a most preferred embodiment, the dispersion of (meth)acrylate copolymer obtained from polymerization of monomers comprising, based on the total monomer weight,
(a) from 20 to 30% by weight of at least one monoethylenical hard monomer;
(b) from 69 to 79% by weight of at least one monoethylenical soft monomer;
(c) from 1 to 2% by weight by weight of at least one monomer represented by Formula (1)

CH₂═C(R¹)CONR²R³Formula(1)
wherein R¹ represents a hydrogen atom or a methyl group, R² is a hydroxyalkyl group containing 2 to 8 carbon atoms and R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

In one embodiment of the present disclosure, the (meth)acrylate copolymer according to the present disclosure may have a Tg in the range of −30 to 10° C., preferably in the range of −20 to 10° C., more preferably in the range of −10 to 0° C. The Tg may affect the tensile strength and adhesion strength.

The radically initiated emulsion polymerization can take place in the presence of an exogenous polymer seed in an amount of 0.04% to 1.5% by weight based on the total weight of all monomers. The exogenous polymer seed is a polymer seed which has been prepared in a separate reaction step or a commercially available polymer seed, whose monomeric composition is different than that of the polymer prepared by the radically initiated emulsion polymerization. The preparation of an exogenous polymer seed is familiar to the skilled person and is typically accomplished by the introduction as initial charge to a reaction vessel of a relatively small amount of monomers and of a relatively large amount of emulsifiers, and by the addition at reaction temperature of a sufficient amount of polymerization initiator. A polystyrene or polymethyl methacrylate polymer seed is particularly preferred. The total amount of exogenous polymer seed is introduced as initial charge to the polymerization vessel before the polymerization reaction is initiated. Total amount of monomers (a) to (d) can be charged to the polymerization vessel continuously in the form of a monomer emulsion under polymerization conditions. Use is made in particular of a polymer seed whose particles have a narrow size distribution and weight-average diameters D_{w} below 100 nm, frequently about 5 nm to about 50 nm, and often about 15 nm to 35 nm.

The radically initiated emulsion polymerization is carried out in the presence of an emulsifier, an initiator and optionally a radical chain transfer agent and other additives which are those conventionally used in the art.

Suitable emulsifiers for preparing the dispersion of (meth)acrylate copolymer according to the present invention include nonionic emulsifers, aninoic emulsifiers, or a combination thereof, preferably anionic emulsifiers. The emulsifier(s) may be used in an amount of 0.1% to 3% by weight based on the total wight of all monomers. The emulsifier(s) may be introduced in the form of a monomer emulsion. It is also possible to introduce a portion of the emulsifier(s) as initial charge to the polymerization vessel before the polymerization reaction is initiated and the remaining amount of the emulsifier(s) is added in the form of a monomer emulsion under polymerization conditions.

Examples of conventional nonionic emulsifiers include ethoxylated mono-, di-, and tri-alkylphenols (EO degree: 3 to 50, alkyl: C₄ to C₁₂) and also ethoxylated fatty alcohols (EO degree: 3 to 80; alkyl: C₆ to C₃₆) wherein EO degree means the degree of ethoxylation. Examples thereof are Lutensol A® grades (C₁₂ to C₁₄, fatty alcohol ethoxylates, EO degree: 3 to 8), Lutensol AO® grades (C₁₃C₁₅ oxo-process alcohol ethoxylates, EO degree: 3 to 30), Lutensol AT® grades (C₁₆C₁₈, fatty alcohol ethoxylates, EO degree: 11 to 80), Emulan TO® grades (C₁₃ oxo-process alcohol ethoxylates, EO degree: 20 to 40), and Lutensol TO® grades (C₁₃ oXo-process alcohol ethoxylates, EO degree: 3 to 20), all commercially available from BASF SE.

Examples of conventional anionic emulsifiers include alkali metal salts and ammonium salts of alkyl sulfates (alkyl: C₅ to C₁₂), of sulfuric monoesters with ethoxylated alkanols (EO degree: 2 to 30, alkyl: C₁₂ to C₁₈) and with ethoxylated alkylphenols (EO degree: 3 to 50, alkyl: C₄ to C₁₂), of alkylsulfonic acids (alkyl: C₁₂ to C₁₈), and of alkylarylsulfonic acids (alkyl: C₉ to Ci₈).

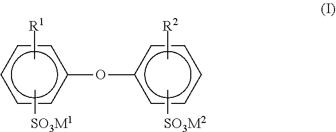

As a suitable anionic emulsifier, compounds of the general formula (I) may also be mentioned

in which R¹ and R² independently are H or C₄₋₂₄ alkyl, preferably linear or branched C₆₋₁₈ alkyl, in particular C₆, C₁₂, or C₁₆ alkyl, and are not simultaneously H, and M¹ and M² can be alkali metal ions and/or ammonium ions, preferably sodium, potassium or ammonium, with sodium being particularly preferred. The compounds (I) are known from U.S. Pat. No. 4,269,749 for example and are available commercially.

Frequently use is made of technical mixtures which contain a fraction of 50% to 90% by weight of the monoalkylated product, such as Dowfax® 2A1 (commercially available from Dow Chemical Company).

Suitable initiators for preparing the dispersion of (meth)acrylate copolymer according to the present invention are free radical water-soluble substances, in particular water-soluble peroxides or persulfates, for example hydrogen peroxide, potassium, sodium and ammonium persulfates, t-butyl hydroperoxide, peracetic acid and so on. Redox catalysts may also be used which consist of peroxides or persulfates of the above types and reducing agents normally used for this purpose, such as ascorbic acid, sodium bisulfide, sodium sulfoxylate and so on. It is possible for two or more initiators to be used in the emulsion polymerization. In general, the initiator(s) may be used in an amount of 0.1% to 3% by weight based on the total weight of all monomers, preferably 0.1% to 2% by weight. The initiator(s) can be introduced as initial charge to the polymerization vessel before the polymerization is initiated. It is also possible to introduce a portion of the initiator(s) as an initial charge to the polymerization vessel before the polymerization is initiated and add the remaining amount continuously under polymerization conditions.

In order to reduce the residual monomers, it is common to further add an initiator after the end of the substantial emulsion polymerization, i.e., after a monomer conversion of at least 95%.

In addition to the aforementioned components, a radical chain transfer agent may also be used to control the molecular weight of the copolymer obtained by the polymerization. The amount of the chain transfer agent is generally below 5% by weight based on the total weight of all monomers, preferably below 1% by weight. Particularly, organic thiol compounds are suitable as the chain transfer agent, such as t-dodecyl mercaptan.

The radically initiated emulsion polymerization is carried out at a temperature in the range from 50 to 120° C., preferably 70 to 95° C.

The dispersion of (meth)acrylate copolymer containing a hydroxyalkyl (meth)acrylate comonomer unit according to the present disclosure can also comprise conventional additives known in the art, such as antimicrobial agent, antifoaming agent, antioxidant and so on. Such additives may be introduced into the dispersion after the completion of the polymerization.

The dispersion of (meth)acrylate copolymer containing a hydroxyalkyl (meth)acrylate comonomer unit according to the present disclosure has a polymer solid content of from 40 to 60% by weight. It is to be understood that the dispersion may be diluted with water to any desired solid content according to specific applications. The number-average particle diameter (cumulant z-average) of the polymer particles dispersed in the dispersion is generally in the range of 50 to 1000 nm, preferably in the range of 50 to 750 nm, most preferably in the range of 100 to 500 nm.

The weight average molecular weight Mw of the copolymer contained in the dispersion according to the present disclosure ranges from 10,000 to 1,000,000 g/mol, preferably from 50,000 to 500,000 g/mol, most preferably from 100,000 to 300,000 g/mol. The copolymer contained in the dispersion according to the present disclosure has a Mw/Mn ratio in the range of 1 to 10, preferably in the range of 1 to 5, most preferably in the range of 2 to 4.

The present invention further relates to use of the dispersion of (meth)acrylate copolymer containing a hydroxyalkyl (meth)acrylate comonomer unit according to the present invention for flexible cementitious waterproofing materials. The composition and preparation of said dispersion are as discussed in detail hereinabove.

There are no specific limitations for the cement contained in the cementitious materials. Any known cements such as high alumina cements and silicate cements may be used. The silicate cements herein include, but are not limited to, Portland cements, pozzolanic cements, hydraulic limes, fly ash and natural cements.

The cementitious materials also comprise conventional additives known in the art. The additives include, but are not limited to, inorganic fillers such as calcium carbonate, quartz sand, dolomite, fumed silica, kaolin, talc and mica, rheology modifiers such as Walocel® MW 40000, Latekol® D and Starvis® 3003 F, superplasticizers such as Melflux® 2651 F, defoamers such as Lumiten® EL and Foamaster® NXZ, coalescence agents such as Texanol®, plasticizers such as Plastilit® 3060, and so on.

The dispersion of (meth)acrylate copolymer according to the present disclosure is used in an amount of 10% to 100% by weight in terms of the solid content, relative to the weight of cement in the flexible cementitious waterproofing materials.

The dispersion of (meth)acrylate copolymer containing a hydroxyalkyl (meth)acrylate comonomer unit according to the present invention may be mixed with other components such as cements, sand and optional additives which together with said dispersion constitute flexible cementitious waterproofing materials in situ immediately before application thereof. The said dispersion may be homogeneously mixed with the flexible cementitious waterproofing materials via any mixing or blending means.

Additionally, the present invention provides cementitious materials containing the (meth)acrylate copolymer powder obtained from the dispersion of (meth)acrylate copolymer containing a (meth)acrylate comonomer unit according to the present disclosure. For the components that may be used in the cementitious materials other than the (meth)acrylate copolymer powder, reference may be made to those described hereinabove.

It is to be understood that the (meth)acrylate copolymer powder obtained from the dispersion of (meth)acrylate copolymer containing a (meth)acrylate comonomer unit according to the present invention as described above is used in an amount of 10% to 100% by weight relative to the weight of cement in the cementitious materials.

The present invention is further demonstrated and exemplified in the Examples, however, without being limited to the embodiments described in the Examples.

### EXAMPLES

In the context of the present invention, tensile strength and adhesive strength are measured according to GB/T 23445-2009, “Test Method of Building Waterproofing Coatings”, 1st edition, June 2008. The ammonia release and aldehyde release from the dispersion is measured according to JC 1066-2008. The polymer solid content of the dispersion is determined by drying the dispersion in oven at 140° C. for 30 minutes according to ISO 3251:2008.

Tg for the copolymers of the present invention is measured by differential scanning calorimetry (DSC), taking the mid-point in the heat flow versus temperature transition as the Tg value. The temperature is increased with 10° C. per minute during the DSC test.

Disponil LDBS 23 IS: surfactant, Sodium n-alkyl-(C₁₀-C₁₃)alkylbenzene sulfonate, from BASF, Germany
Seed 6772: Pre-product 6772, a polystyrene seed, from BASF NaPS (sodium persulfate) solution, 7 wt. %, from ABC UNITED-INITIATORS HEFEI
LIMITED COMPANY
styrene (ST): from BASF
n-butyl acrylate (BA): from BASF
ethyl acrylate (EA): from BASF
2-Ethylhexyl acrylate (EHA): from BASF
methyl methacrylate (MMA): from BASF
N, N-Bis(2-hydroxyethyl) methacrylamide (NN-MAM): from BASF
N-2-hydroxyethyl-acrylamide (HEAA): from KJ Chemical
N-methylol (meth)acrylamide (N-MAM): from KJ Chemical

### Example 1

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 300 g styrene (ST), 690 g n-butyl acrylate (BA) and 10 g N-2-hydroxyethyl-acrylamide (HEAA) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Example 2

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 200 g styrene (ST), 300 g ethyl acrylate (EA), 485 g n-butyl acrylate (BA) and 15 g N-2-hydroxyethyl-acrylamide (HEAA) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Example 3

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 200 g styrene (ST), 495 g ethyl acrylate (EA), 290 g 2-Ethylhexyl acrylate (EHA) and 15 g N-2-hydroxyethyl-acrylamide (HEAA) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Example 4

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 270 g styrene (ST), 100 g ethyl acrylate (EA), 320 g n-butyl acrylate (BA), 300 g 2-Ethylhexyl acrylate (EHA) and 10 g N-2-hydroxyethyl-acrylamide (HEAA) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Example 5

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 300 g styrene (ST), 690 g n-butyl acrylate

(BA) and 10 g N,N-Bis(2-hydroxyethyl) methacrylamide (NN-MAM) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Example 6

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 280 g methyl methacrylate (MMA), 685 g n-butyl acrylate (BA) and 15 g N-2-hydroxyethyl-acrylamide (HEAA) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

### Comparative Example 1

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 297 g styrene (ST), 688 g n-butyl acrylate (BA) and 15 g acrylamide were fed constantly over 5 hours. And 43 g NaPS 7 wt. %

solution was charged and the dispersion was post polymerizing for another 1 hour. Finally, the pH and solid content of the final product was adjusted to 7.2 and 50 wt. %, respectively.

### Comparative Example 2

To a 5 L automated reactor, 500 g DI water, 12 g Disponil LDBS 23 IS and 10 g of Seed 6772 were charged. The mixture was heated up to 75° C. When the temperature was stable, 71 g 7 wt. % NaPS (sodium persulfate) solution was charged within 2 minutes and stirred for another 3 minutes. When the temperature reaches 75° C. again, a monomer mixture comprising 300 g styrene (ST), 690 g n-butyl acrylate

(BA) and 15 g N-methylol (meth)acrylamide (N-MAM) were fed constantly over 5 hours. And 43 g NaPS 7 wt. % solution was charged and the dispersion was post polymerizing for another 1 hour. Finally, the pH and solid content of the final product was adjusted to 7.2 and 50 wt. %, respectively.

The composition of (meth)acrylate copolymer and the performance are listed in the Table 1 as below.

TABLE 1

| | Ammonia | Aldehyde | Tensile | Adhesion | |
|---|---|---|---|---|---|
| | Value | Value | Strength | Strength | Tg |
| Examples | (ppm) | (ppm) | (MPa) | (MPa) | (° C.) |
| Example 1 | 340 | Undetected* | 2.4 | 1.0 | −11.7 |
| Example 2 | 273 | Undetected* | 3.0 | 1.2 | −9.5 |
| Example 3 | 351 | Undetected* | 3.1 | 1.3 | −3.5 |
| Example 4 | 253 | Undetected* | 2.7 | 1.2 | −17.5 |
| Example 5 | 264 | Undetected* | 2.5 | 1.3 | −8.1 |
| Example 6 | 241 | Undetected* | 2.1 | 1.4 | −10 |
| Comparative | 1717 | Undetected* | 2.2 | 1.0 | −9.9 |
| Example 1 | | | | | |
| Comparative | 327 | 1143 | 2.4 | 1.2 | −9.7 |
| Example 2 | | | | | |

*The detection limit of aldehyde with the HPLC instrument is 3 ppm. If the content of aldehyde is under 3 ppm, the instrument could not detect it.

1-12. (canceled)

13. A dispersion of (meth)acrylate copolymer obtained from polymerization of monomers comprising, based on the total monomer weight,
(a) from 10 to 45% by weight of at least one monoethylenical hard monomer;
(b) from 54 to 89% by weight of at least one monoethylenical soft monomer (b);
(c) from 0.5 to 5.0% by weight of at least one monomer represented by Formula (1)
CH₂═C(R¹)CONR²R³ Formula (1)
wherein R¹ represents a hydrogen atom or a methyl group, R² is a hydroxyalkyl group containing 2 to 8 carbon atoms and R³ is H, alkyl or hydroxyalkyl group containing 2 to 8 carbon atoms; and
(d) from 0 to 25% by weight of monoethylenically unsaturated monomers containing at least one functional group selected from the group consisting of carboxyl, carboxylic anhydride, sulfonic acid, phosphoric acid and hydroxyl.

14. A dispersion according to claim 13, wherein the R² is a hydroxyalkyl group containing 2 to 6 carbon atoms R³ is H, C₁-C₆ alkyl or hydroxyalkyl group containing 2 to 6 carbon atoms.

15. A dispersion according to claim 13, wherein the monomer (c) is chosen from N-(2-hydroxyethyl) acrylamide, N,N-Bis(2-hydroxyethyl) methacrylamide or mixture thereof.

16. A dispersion according to claim 13, wherein the at least one monoethylenical hard monomer (a) is selected from methyl methacrylate, t-butyl acrylate, benzyl methacrylate, ethyl methacrylate, maleic acid vinyl alcohol, vinyl acetate, vinyl butyrate, vinyl formate, vinyl valerate, vinyl versitat, monovinyl aromatic monomer and any mixtures thereof.

17. A dispersion according to claim 13, wherein the at least one monoethylenical soft monomer (b) may include, but not limited to, methyl acrylate, n-butyl acrylate, 2-ethylhexyl acrylate, isooctyl acrylate, nonyl acrylate, ethyl acrylate, decyl methacrylate, isodecyl methacrylate, hexyl(meth)acrylate, cyclohexyl acrylate, dodecyl (meth)acrylate, octyl methacrylate, propyl acrylate, ethylene adipate, diethyl fumarate, 1,4-butadiene, 1-pentenylene, di-2-ethylhexyl maleate, di-2-ethylhexyl fumarate and mixtures thereof.

18. A dispersion according to claim 13, wherein at least one monoethylenical hard monomer is used in an amount of 15% to 45% based on the total weight of all monomers.

19. A dispersion according to claim 18, wherein at least one monoethylenical soft monomer (b) is used in an amount of 54% to 84% based on the total weight of all monomers.

20. A dispersion according to claim 19, wherein the monomer (c) is used in an amount of 0.5% to 4% based on the total weight of all monomers.

21. A dispersion according to claim 19, wherein the monomer (d) is used in an amount of 0.5% to 25% based on the total weight of all monomers.

22. A dispersion according to claim 13, wherein the Tg of the copolymer is-30 to 10° C.

23. 11 (New) A dispersion according to claim 13, wherein Mw of the copolymer is 10,000 to 1,000,000 g/mol.

24. A cementitious material comprising the dispersion of (meth)acrylate copolymer according to claim 13.
